(19) United States
(12) Patent Application Publication
(10) Pub. No.: US 2009/0260409 A1
(43) Pub. Date: Oct. 22, 2009

(54) Door Lock Device

(75) Inventor: June-Young Lee, Gimhae-City (KR)

Correspondence Address: HYUN JONG PARK;Park & Associates IP Law LLC, 265 Bic Drive, Suite 106, Milford, CT, 06461, US

(73) Assignee: Poong Won Industry Co., Ltd., Gimhae-City (KR)

(21) Appl. No.: 12/165,956

(22) Filed: Jul. 1, 2008

(30) Foreign Application Priority Data
Apr. 22, 2008 (KR) 10-2008-0037124

(51) Int. Cl. E05B 49/00

(52) U.S. Cl. 70/278.7

(57) ABSTRACT

Provided is a door lock device. The device includes a fixing rack, an operation rack, a solenoid device, an engaged fragment, and a locking pin. The fixing rack is installed in a receptacle and has a hinge shaft. The operation rack is coupled with the hinge shaft. The solenoid device is installed in the receptacle and has a rod. The engaged fragment is assembled to the rod and ascends or descends. The locking pin is installed in the operation rack and performs a locking or unlocking function.

### FIELD OF THE INVENTION

The present invention relates to a door lock device. More particularly, the present invention relates to a door lock device in which, for the purpose of protecting a user from a heat generated at the time of execution of a self-cleaning function of an oven, a solenoid device is installed in a receptacle to forcibly lock the door, thereby preventing the user from artificially opening the door.

### BACKGROUND OF THE INVENTION

As well known in the art, a cooking oven is a cooking instrument for receiving and cooking food by a radiant heat and a convection heat within a cavity of the oven.

As the oven is diversified in its function, even kind of cookable food increases, so its use increases. Therefore, an opportunity of contaminating the internal of the cavity owing to food dregs, etc. increases that much. In order to clean the stained cavity, the oven generally has a self-cleaning function.

The self-cleaning function refers to a function of cleanly cleaning the cavity internal by keeping the cavity internal of the cooking oven at about 450° C. for a predetermined time (about 15 minutes to the minimum), thermally analyzing food contaminants accumulated in the internal, and then exhausting out gas and smoke generated from the thermal analysis. The self-cleaning function requires processes of increasing a temperature of the cavity internal to a high temperature of about 400° C., maintaining the high-temperature cavity internal for about 15 minutes, and then again cooling the cavity internal. In general, it takes two hours or more to complete all the processes.

During the operation processes, the cavity is kept at a high temperature. Thus, a careless infant or user may get burned because of a heat emitted out when a door is opened. In order to prevent this accident, the oven door is now equipped with a safety device. However, because the safety device is generally installed at the outside of the door, the user may undesirably open the door by force, thus reducing by half a function of a lock device and also having poor appearance.

### SUMMARY OF THE INVENTION

An aspect of exemplary embodiments of the present invention is to address at least the problems and/or disadvantages and to provide at least the advantages described below. Accordingly, an aspect of exemplary embodiments of the present invention is to provide a door lock device for forcibly keeping a door in a lock state at the time of execution of a self-cleaning function of an oven.

According to one aspect of exemplary embodiments of the present invention, provided is a door lock device. The device includes a fixing rack, an operation rack, a solenoid device, an engaged fragment, and a locking pin. The fixing rack is installed in a receptacle of an oven and has a hinge shaft. The operation rack is coupled with the hinge shaft of the fixing rack to open/close a door. The solenoid device is installed in the receptacle and has a rod. The engaged fragment is assembled to the rod of the solenoid device and ascends or descends depending on an operation of the solenoid device. The locking pin is installed in the operation rack and performs a locking or unlocking function depending on an operation of the engaged fragment.

### BRIEF DESCRIPTION OF THE DRAWINGS

The above and other objects, features and advantages of the present invention will become more apparent from the following detailed description when taken in conjunction with the accompanying drawings in which:

FIG. 1 is a side cross-section illustrating an assembly structure of a door lock device according to an exemplary embodiment of the present invention;

FIG. 2 is an exploded perspective diagram illustrating concrete constituent elements of a locking means of the door lock device of FIG. 1;

FIG. 3 is a block diagram illustrating a construction of a door lock device according to an exemplary embodiment of the present invention;

FIG. 4 is a cross section illustrating a state of enabling a locking function of a door lock device according to an exemplary embodiment of the present invention; and

FIG. 5 is a cross section illustrating a state of disabling a locking function of a door lock device according to an exemplary embodiment of the present invention.

Throughout the drawings, the same drawing reference numerals will be understood to refer to the same elements, features and structures.

### DETAILED DESCRIPTION OF THE INVENTION

Exemplary embodiments of the present invention will now be described in detail with reference to the annexed drawings. In the following description, a detailed description of known functions and configurations incorporated herein has been omitted for conciseness.

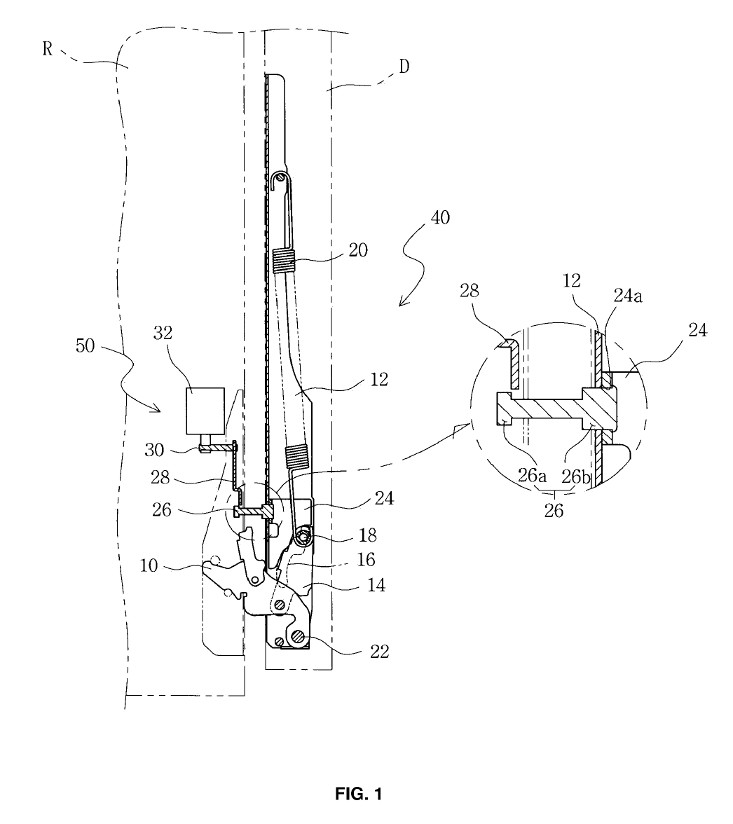

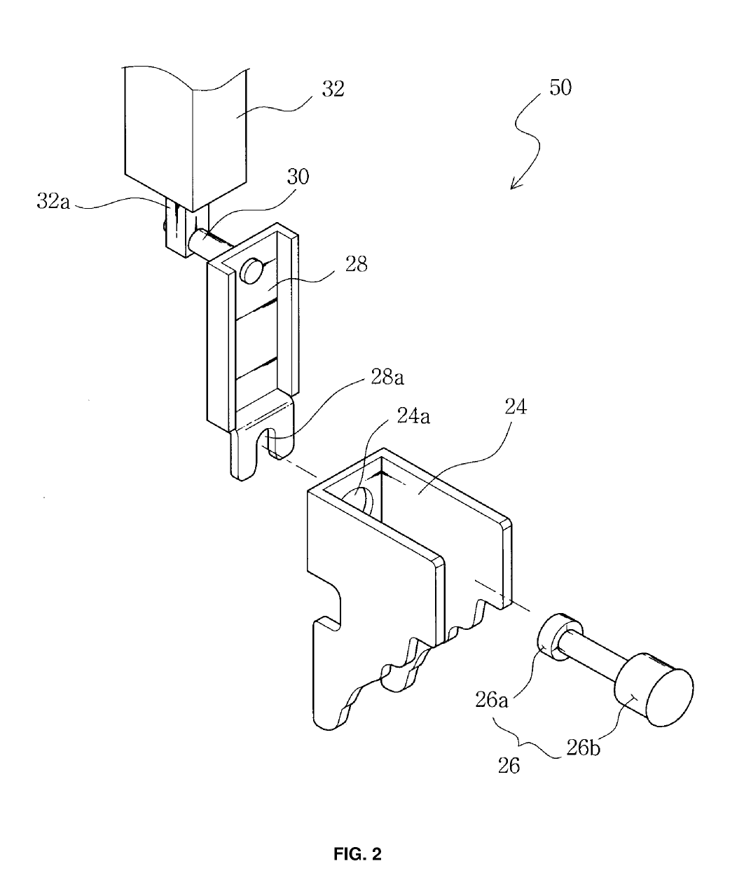

FIGS. 1 to 3 are diagrams illustrating a construction of a door lock device according to an exemplary embodiment of the present invention. The door lock device includes a door hinge 40 and a locking means 50. The door hinge 40 includes a fixing rack 10. The fixing rack 10 is installed in a receptacle (R) and supports constituent parts of the door hinge 40. The door hinge 40 includes an operation rack 12, a rotary plate 14, and a connection member 24. The operation rack 12 is coupled with the fixing rack 10 by a hinge shaft 22 and rotates centering on the hinge shaft 22 at a time a door (D) is opened and closed.

The operation rack 12 is bent to have a [symbol] shape. The rotary plate 14 and the connection member 24 are installed within the operation rack 12. The connection member 24 is bent and formed within the operation rack 12 to have a [symbol] shape and has a fitting hole 24a into which a locking pin 26 described later is fitted. The operation rack 12 has guide holes 16 at its both sides such that a guide pin 18 described later can move up/down at a time the door (D) rotates. The guide pin 18 is fitted into the guide holes 16. The guide pin 18 is coupled with the rotary plate 14 and moves riding in the guide holes 16. The guide pin 18 is fitted to a spring 20 installed in the operation rack 12. The spring 20 is installed on the operation rack 12 at its one side and installed on the guide pin 18 at the other side. When the door (D) is opened, the spring 20 moves along the guide pin 18, enabling smooth opening of the door (D) by a tension force.

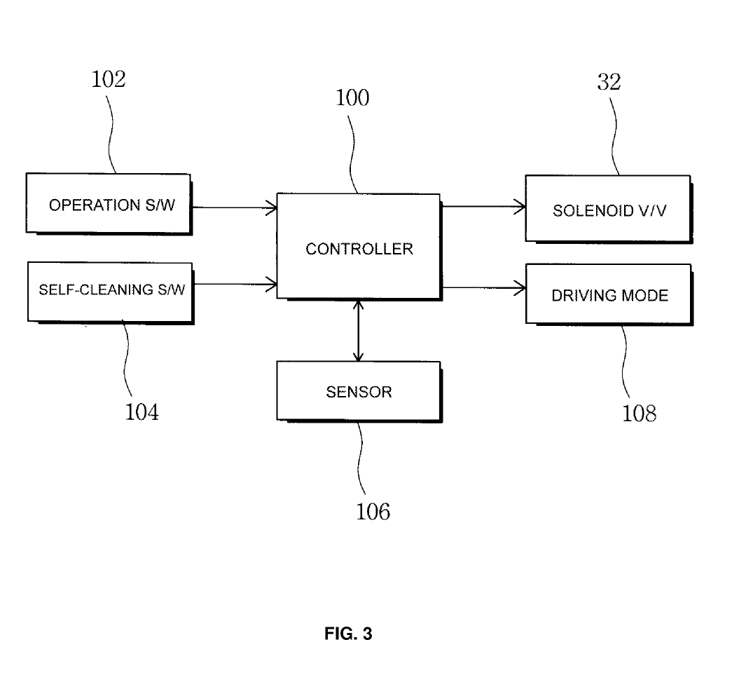

The fixing rack 10 is installed in the receptacle (R). A solenoid device 32 is installed at an upper side of the fixing rack 10. The solenoid device 32 forcibly locks the door (D) at the time of execution of a self-cleaning function of an oven and unlocks the locked door (D) at the time of completion of the self-cleaning function. These are performed through an engaged fragment 28 and the locking pin 26. The self-cleaning function is implemented in a controller 100 depending on switching of a self-cleaning switch 104 shown in FIG. 3. In addition, an operation switch 102 is a switch for operating the oven. Depending on switching of the operation switch 102, the controller 100 enables a driving mode 108 for executing an oven function. A temperature sensor 106 senses an internal temperature of the oven and transmits the sensed temperature to the controller 100.

A link 30 is fitted to a rod 32a of the solenoid device 32 at its one end and is fitted to the engaged fragment 28 at the other end. The engaged fragment 28 is formed in a rectangular shape. The engaged fragment 28 is bent at its lower end part and has a fitting part 28a having a long-hole shape by cutaway starting from a center. Opening the fitting part 28a in a long-hole shape is to facilitate holding of the locking pin 26 formed in a cylindrical shape.

The locking pin 26 is fitted into the fitting part 28a. The locking pin 26 is fitted into or released from the fitting part 28a depending on an operation of the solenoid device 32. That is, the locking pin 26 is formed in a cylindrical shape and has a cylindrical fitting protrusion 26a protruded and formed in its rear. The fitting protrusion 26a gets in contact with a rear surface of the fitting part 28a and prevents user's artificial opening when a user undesirably intends to open the locked door (D).

A cylindrical protrusion 26b is protruded and formed in front of the locking pin 26 and is fitted into the fitting hole 24a of the connection member 24. The locking pin 26 is assembled such that the locking pin 26 is fitted into the fitting hole 24a of the connection member 24 and is not released from the fitting hole 24a by the cylindrical protrusion 26b. In an alternate method, the connection member 24 can perform the same function by providing a separate hole in the operation rack 12 and fitting the locking pin 26 into the hole of the operation rack 12.

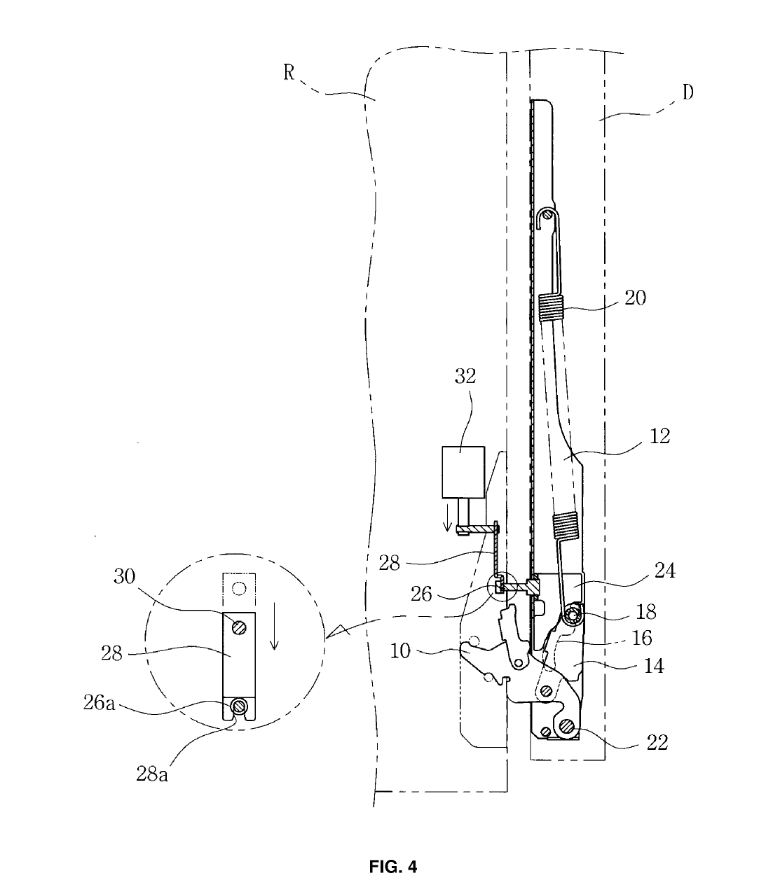

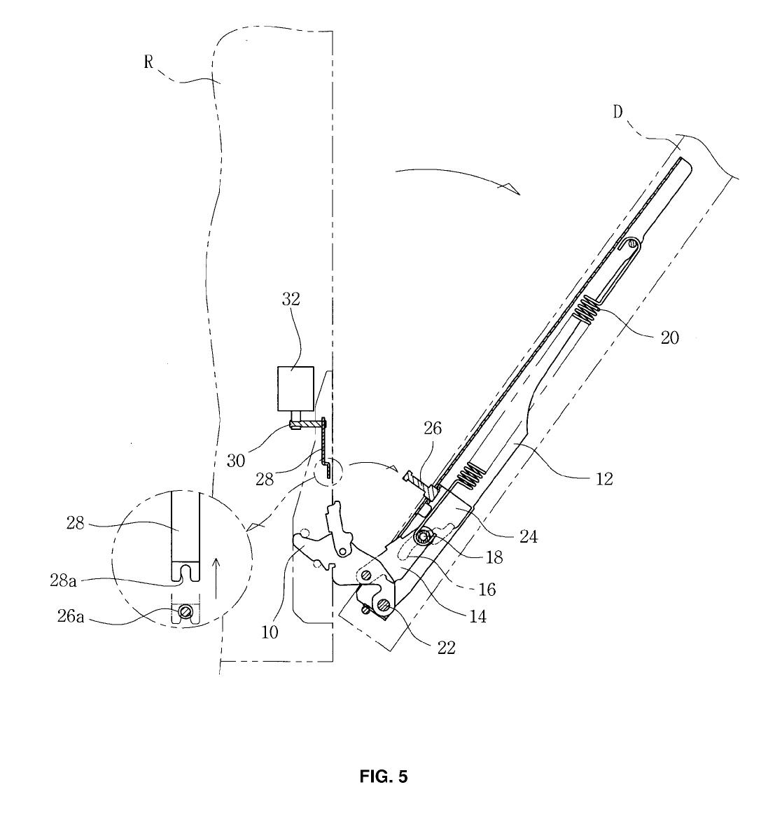

Operation of the above-constructed door lock device according to an exemplary embodiment of the present invention is described below with reference to accompanying FIGS. 3 to 5. A rotation operation of the door hinge 40 included in the door lock device according to an exemplary embodiment of the present invention is a well-known technology and thus, its detailed description is omitted below.

Depending on switching of an operation switch 102, a controller 100 enables a driving mode 108 and performs an oven function. The controller 100 switches on a self-cleaning switch 104 to perform a self-cleaning function after food is cooked. Depending on switching of the self-cleaning switch 104, the controller 100 enables a solenoid device 32, so a rod 32a installed in the solenoid device 32 descends and a link 30 coupled to the rod 32a descends together.

Then, at the same time when the link 30 descends, even an engaged fragment 28 coupled to the link 30 descends and a fitting part 28a of the engaged fragment 28 is fitted to a locking pin 26. By this, when a user undesirably intends to open a door (D) by force, a rear surface of the fitting part 28a gets in contact with a front surface of the fitting protrusion 26a of the locking pin 26, thus avoiding artificially opening the door (D).

Then, if the self-cleaning function of the oven is completed and a temperature decreases below a predetermined temperature (desirably, a room temperature of 30° C. to 50° C. with no danger of a burn), a temperature sensor 106 senses and transmits the temperature to the controller 100 and the controller 100 sends an electrical signal to the solenoid device 32 to disable a locking function. At this time, a locking means 50 initiates an unlocking operation inverse to a locking operation. As the rod 32a ascends, the link 30 coupled to the rod 32a also ascends. After that, the engaged fragment 28 coupled to the link 30 ascends, so coupling between the locking pin 26 and the engaged fragment 28 is released. After that, a user can open the door (D) with catching a handle (not shown) of the door (D).

Meantime, in order for the user to manually open the door upon occurrence of power failure or emergency after completion of the self-cleaning function, a separate hole or open/closable small door can be provided at a point where the locking means 50 is installed, desirably, at the receptacle (R) such that the user can move up the engaged fragment 28 in the external.

As described above, exemplary embodiments of the present invention provide an effect of preventing a careless infant or user from getting burned because of an internal heat when artificially opening a door, by installing a solenoid device in a receptacle of an oven to forcibly lock the door at the time of execution of a self-cleaning function of the oven.

Further, there is an effect of providing a good appearance by installing a locking device within the receptacle.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A door lock device comprising:
a fixing rack installed in a receptacle of an oven and has a hinge shaft;
an operation rack coupled with the hinge shaft of the fixing rack to open/close a door;
a solenoid device installed in the receptacle and having a rod;
an engaged fragment assembled to the rod of the solenoid device and ascending or descending depending on an operation of the solenoid device; and
a locking pin installed in the operation rack and performing a locking or unlocking function depending on an operation of the engaged fragment.

2. The device of claim 1, wherein the engaged fragment has a fitting part formed through partial cutaway.

3. The device of claim 1, wherein the locking pin has a fitting protrusion protruded and formed at its one side.
